(19) United States
(12) Patent Application Publication
(10) Pub. No.: US 2014/0082661 A1
(43) Pub. Date: Mar. 20, 2014

(54) LOW LATENCY VIDEO STORYBOARD DELIVERY WITH SELECTABLE RESOLUTION LEVELS

(71) Applicant: Google Inc., Mountain View, CA (US)

(72) Inventors: Nils Oliver Krahnstoever, Brookline, MA (US); Kevin William Wilson, Cambridge, MA (US)

(73) Assignee: Google Inc., Mountain View, CA (US)

(21) Appl. No.: 13/785,913

(22) Filed: Mar. 5, 2013

Related U.S. Application Data
(60) Provisional application No. 61/607,067, filed on Mar. 6, 2012.

(51) Int. Cl. H04N 21/81; H04N 21/435

(52) U.S. Cl. CPC H04N 21/8126; H04N 21/435
USPC 725/32

(57) ABSTRACT

A video storyboard delivery system is disclosed. The system receives, from a playback client executed on a user device, a request for a video including one or more user device parameters. The system obtains a storyboard manifest including information defining a storyboard associated with the video, wherein the information includes a plurality of storyboard resolution levels. Using the one or more user device parameters, a selection is made of one of the plurality of storyboard resolution levels from the storyboard manifest. The storyboard at the selected resolution level is delivered to the playback client.

### CROSS-REFERENCE TO RELATED APPLICATION

This application is related to and claims the benefit of U.S. Provisional Patent Application No. 61/607,067, filed Mar. 6, 2012, which is hereby incorporated by reference herein.

### TECHNICAL FIELD

Aspects and implementations of the present disclosure relate to the field of video delivery services and, more particularly, to the delivery of storyboards associated with a video.

### BACKGROUND

Users watching videos served through the Internet on web sites, TVs and mobile devices often have the desire to skip forward or backward in the video. Changing the playback location in a video playback is often performed with a slider bar (e.g., a seek bar or a scrub bar). The user selects a small slide button and slides a pointer representing the present playback location to a desired location on the slider bar that represents a corresponding time location in the video. Typically, a storyboard, or arrangement of video frames corresponding to the underlying video are presented to the user and arranged along the slider bar to allow the user to select a playback location using a corresponding image of the storyboard.

For playback of encoded video streams, a change in playback location usually requires an interruption of the data stream being delivered from the source of the video (e.g., back-end video servers) and the video player software such that the video stream can be restarted at the new desired video playback location. This interruption of the video stream produces latency, and the user is often exposed to several seconds of delay until the video continues playback at the new time location. Moreover, this latency issue can be exacerbated by the conventional method of presenting storyboards to a user at a single resolution, irrespective of the bandwidth or resolution of the user's video player. Furthermore, the user is unable to view video frames that correspond to different slide bar locations as the user is sliding the playback marker along the slider.

In addition, many video delivery services provide real-time streaming of video (e.g., a live video stream), but fail to provide the user with a storyboard corresponding to the previously streamed portion of the video to allow the user to select a playback position prior to the current playback location.

### SUMMARY

The following presents a simplified summary of various aspects of this disclosure to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a system and method are presented for providing visual feedback to a user during selection of a location in a video (e.g., scrubbing) in the form of a video storyboard (e.g., a storyboard) including an arrangement of video frames each representing a playback location of the video. The storyboard associated with a video is maintained at multiple resolution levels.

In an implementation, the system and method are configured to receive, from a playback client executed on a user device, a request for a video including one or more user device parameters. The system and method obtain a storyboard manifest including information defining a storyboard associated with the video, wherein the information includes a plurality of storyboard resolution levels. Using the one or more user device parameters, a selection is made of one of the plurality of storyboard resolution levels from the storyboard manifest. The storyboard at the selected resolution level is then delivered to the playback client.

In another implementation, a system and method of delivering a video storyboard associated with a live video stream are presented. The system and method are configured to receive a live video stream and perform multi-frame sampling of the live video stream to produce a plurality of video frames. The system and method are further configured to generate a storyboard including the plurality of video frames and deliver the storyboard associated with the live video stream to a playback client executed on a user device.

In additional implementations, computing devices for performing the operations of the above described implementations are also provided. Additionally, in implementations of the disclosure, a computer readable storage media stores instructions for performing the described operations.

### BRIEF DESCRIPTION OF THE DRAWINGS

The present disclosure will be understood more fully from the detailed description given below and from the accompanying drawings of various implementations of the disclosure.

FIG. 1 illustrates an exemplary system architecture, in accordance with one implementation of the present disclosure.

FIG. 2 illustrates exemplary storyboard resolution levels of a generated storyboard, in accordance with one implementation of the present disclosure;

FIG. 3 is a flow diagram illustrating instructions for delivering a storyboard to a user device, in accordance with an implementation of the present disclosure.

FIG. 4 is a flow diagram illustrating instructions for delivering a storyboard associated with a live video stream to a user device, in accordance with another implementation of the present disclosure.

FIG. 5 illustrates an exemplary user interface of a playback client displaying exemplary storyboards generated in accordance with implementations of the present disclosure.

FIG. 6 depicts a block diagram of an illustrative computer system operating in accordance with aspects and implementations of the present disclosure.

### DETAILED DESCRIPTION

A system and method for delivery of a storyboard associated with a video to a user device are described. As used herein, the storyboard may include, but is not limited to, a data structure representing periodically sampled frames of a video. In an implementation, the storyboard is a collection of video frames, arranged into a larger frame, like tiles arranged in a mosaic. Advantageously, combining the storyboard frames into larger images (or mosaics) can reduce the number of queries a video player issues to obtain all of the storyboard frames.

In an implementation, the storyboard is generated and stored at multiple spatial and temporal resolutions, each referred herein to as a storyboard resolution level. The multiple storyboard resolution levels represent varying levels of resolution. Implementations of the disclosure generate and store a storyboard manifest for the storyboard associated with a video. The storyboard manifest (also referred to herein as a “manifest”) can include all of the information and parameters that define the storyboard (also referred to herein as “storyboard parameters”). Exemplary storyboard parameters include the storyboard resolution levels, a frame resolution for each storyboard resolution level, a frame sampling temporal frequency, a layout of each mosaic (e.g., the number of rows and columns of video frames in the mosaic), and a number of mosaics for each storyboard resolution level.

In an implementation, a request for a video is received from a user device. The video request includes one or more device parameters associated with the user device. As used herein, device parameters can include any information relating to the user's device and/or video player (or playback client), such as a bandwidth associated with the device (also referred to herein as the device's bandwidth), playback or display resolution capability, rendering capability, computing capability (e.g., CPU capability). Using the device parameters, an appropriate storyboard resolution level is selected and delivered to the user device with the desired video. Advantageously, determining an appropriate storyboard resolution level using the device parameters can allow for an optimized delivery of storyboards to client devices having different parameters. In addition, video players can receive or fetch progressively better storyboards (e.g., progressively higher or better storyboard resolution levels), thereby balancing low latency/fast availability of video storyboard frames with the desire to present higher resolution storyboard frames during the fetching/delivery process.

In another implementation, a system and method of delivering a video storyboard associated with a live video stream for seeking back through already recorded and streamed video is presented. According to this implementation, multi-frame sampling is performed on a live video stream to produce multiple video frames. Next, a storyboard including the multiple video frames associated with the previously recorded/delivered portion of the live video stream is generated and presented to a playback client executed on a user device.

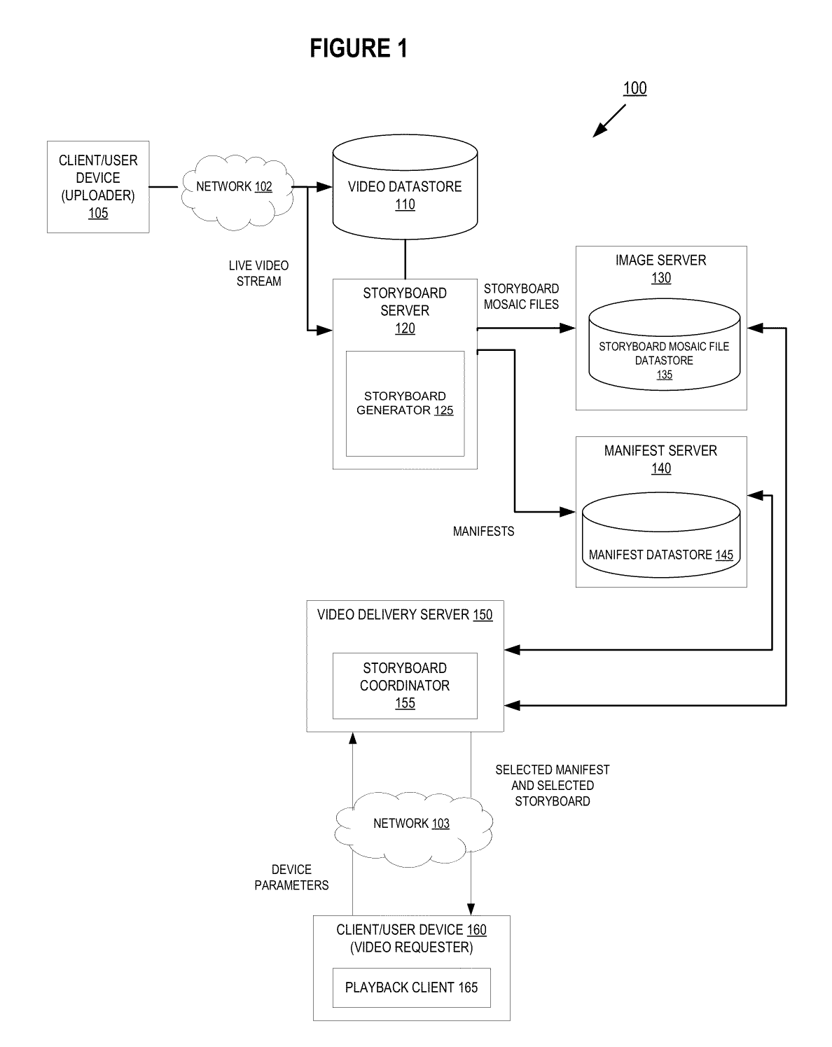

FIG. 1 illustrates an exemplary system architecture 100, in accordance with one implementation of the present disclosure. System 100 includes a storyboard server 120, an image server 130, a manifest server 140, and a video delivery server 150. In addition, one or more client/user devices 105 are in communication with a video data store (e.g., video datastore 110) over a network 102. The network 102 may include the Internet in one implementation. In other implementations, other networks, wired and wireless, such as an intranet, local area network (LAN), wide area network (WAN), cellular network, or broadcast network may be used. The client/user device 105 is configured to provide or upload one or more videos to the video datastore 110 in accordance with any suitable method, technique or protocol.

In addition, one or more client/user devices 160 are in communication with the video delivery server 150 over a network 103. The network 103 may include the Internet in one implementation. In other implementations, other networks, wired and wireless, such as an intranet, local area network (LAN), wide area network (WAN), or broadcast network may be used. One having ordinary skill in the art will appreciate that the network 102 and the network 103 may be the same network, or may be different networks. In an implementation, the client/user device 160 includes a playback client 165 (or video player) configured to request a video from the video delivery server 150 for playback to a user.

The client/user devices 105 and 160 may be any type of computing device, for example, a device including a processing device (e.g., a processor), a computer-readable medium, and a memory. In some implementations, the client/user device 105 may be executing a browser application or other application adapted to communicate over Internet related protocols (e.g., TCP/IP and HTTP) and/or display a user interface. While only a single client/user device 105 is shown in FIG. 1, system 100 may support a large number of concurrent sessions with many client/user devices 105 and 160.

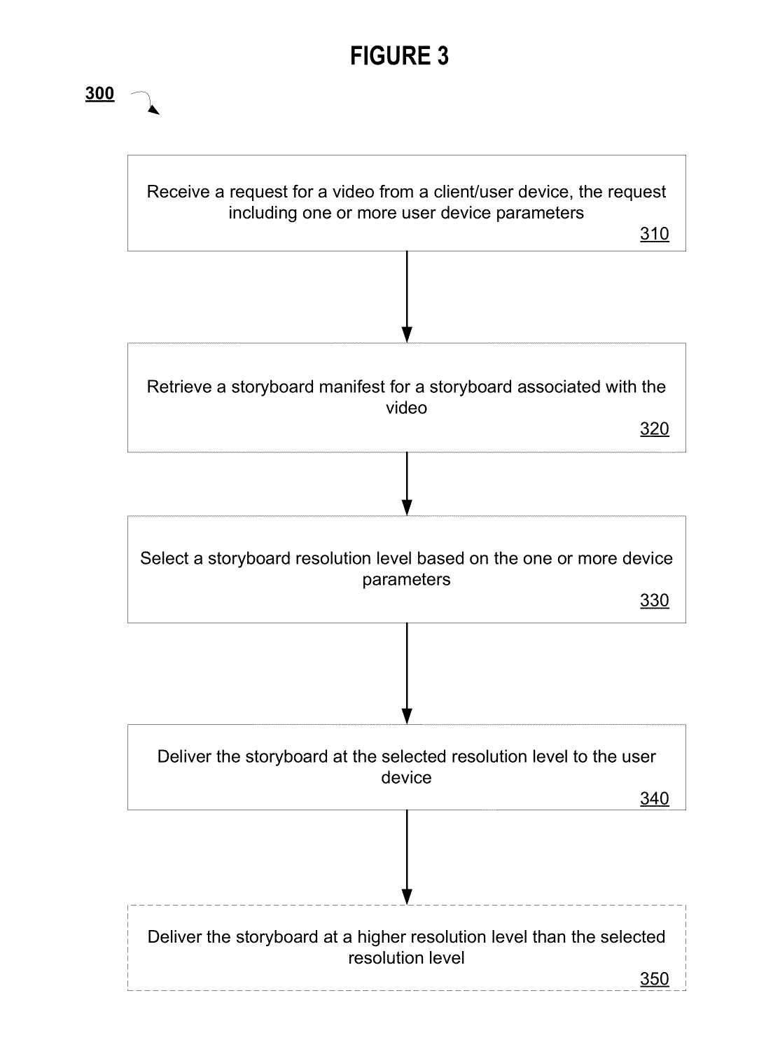

The video delivery server 150 may host a storyboard coordinator 155 that may be implemented in hardware, software, firmware, or any combination of the above. Although shown in FIG. 1 as a component of the video delivery server 150, one having ordinary skill in the art will appreciate that the storyboard coordinator 155 may be a component of one or more of the storyboard server 120, the image server 130, the manifest server 140, the video delivery server 150, and the client/user device 160. In an implementation, the storyboard coordinator 155 is configured to receive and process video requests from the client/user devices 160, one implementation of which is described in more detail with respect to FIG. 3.

The storyboard server 120 may host a storyboard generator 125 that may be implemented in hardware, software, firmware, or any combination of the above. Although shown in FIG. 1 as a component of the storyboard server 120, one having ordinary skill in the art will appreciate that the storyboard generator 125 may be a component of one or more of the image server 130, the manifest server 140, the video delivery server 150, storyboard server 120 and the client/user device 160. In an implementation, the storyboard generator 125 is communicatively connected to the video datastore 110 and is configured to generate a storyboard at one or more storyboard resolution levels for the videos in the video datastore 110.

As shown in FIG. 1, the storyboard generator 125 is also communicatively connected to an image server 130. The storyboard generator 125 may be configured to provide a storyboard mosaic file corresponding to each generated storyboard mosaic to the image server 130 for storage in an associated storyboard mosaic file data store (e.g., storyboard mosaic file datastore 135). In an implementation, the storyboard mosaic file datastore 135 may be a distributed replicated file datastore. In another implementation, the distributed replicated file datastore is equipped with a front-end cache server configured to maintain frequently used storyboard mosaics in a fast access memory or fast access storage device. Each storyboard mosaic file may be assigned a unique filename (e.g., the mosaic filename) under which the mosaic image may be stored in the storyboard mosaic file datastore 135. In an implementation, the mosaic filename is a universal resource locator (URL) that may be used to identify the location of the mosaic image.

Also as shown in FIG. 1, the storyboard generator 125 is also communicatively connected to the manifest server 140. The storyboard generator 125 is configured to provide a manifest associated with each generated storyboard file. As described above, the manifest includes storyboard parameters, including, for example, one or more storyboard resolution levels, a frame resolution for each storyboard resolution level, a frame sampling temporal frequency, a layout of each mosaic (e.g., the number of rows and columns of video frames in the mosaic), and a number of mosaics for each storyboard resolution level. In an implementation, each manifest is assigned a unique filename (e.g., the manifest filename) that is associated with an identifier corresponding to the video that the storyboard manifest represents. The manifest server 140 includes or is communicatively connected to a manifest data store (e.g., the manifest datastore 145), which is configured to store the multiple manifests provided to the manifest server 140. In an implementation, the manifest datastore 145 may be a distributed replicated file datastore. In another implementation, the distributed replicated file datastore is equipped with a front-end cache server configured to maintain frequently used storyboard mosaics in a fast access memory or fast access storage device. The manifest (or manifest file) may be any suitable file type, such as, for example, a text file or a binary file.

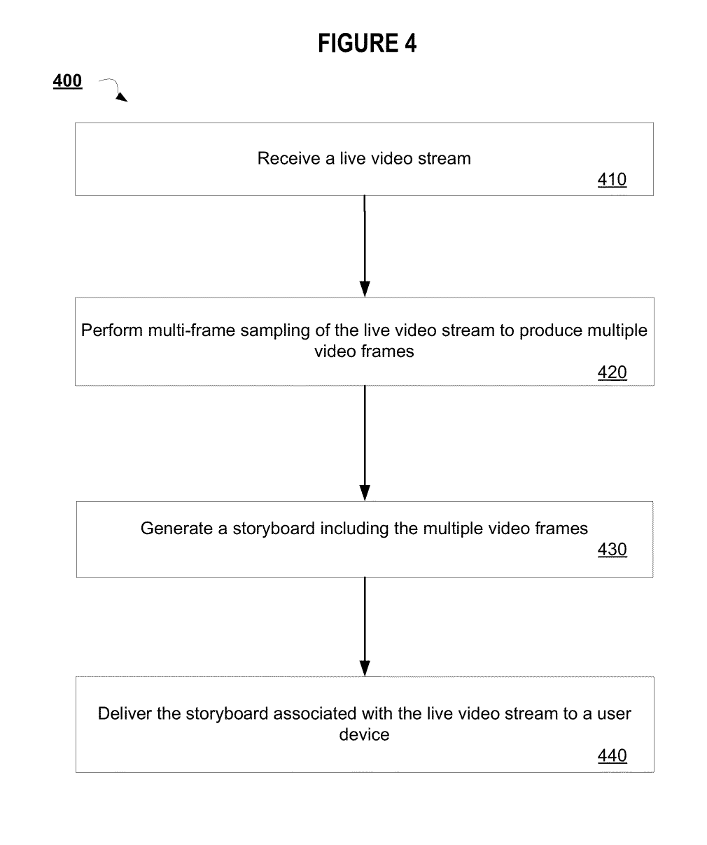

According to an implementation, the storyboard generator 125 is configured to receive a live video stream and generate a storyboard using the live video stream for delivery to the client/user device 160, one implementation of which is described in detail with respect to FIG. 4.

The manifest server 140 may be communicatively connected to the video delivery server 150 and configured to server transformed storyboard manifests to the client/user device 160. The client/user device 160 may be configured to communicate directly with the image server 130 and/or the manifest server 140, without an intermediate video delivery server 150.

The manifest server 140 is configured to receive the video request including the device parameters from the client/user device 160 (either directly or via the intermediate video delivery server 150, for example). The manifest server 140 fetches the manifest associated with the requested video from the manifest data store (e.g., manifest datastore 145) and modifies or transforms the original manifest in accordance with the device parameters. For example, a low storyboard resolution level may be appropriate for a low-bandwidth mobile device, while a high storyboard resolution level may be appropriate for a high-resolution, high-bandwidth game console video player connected via a cable modem. The client/user device 160 sends the video request including its device parameters. In response, the manifest server 140 retrieves the original manifest associated with the requested video from the manifest datastore 145 and transforms the manifest by removing the storyboard resolution levels that do not match the resolution level of the client/user device 160. The manifest server 140 then transmits the transformed manifest to the client/user device 160 (either directly or via the video delivery server 150).

In an implementation, the request for a video received from the client/user device 160 includes information identifying the video (e.g., a video identifier). In an implementation, the playback client 165 of the client/user device 160, the video delivery server 150, and/or the manifest server 140 are configured to infer or determine the manifest filename from the video identifier, to enable the fetching of the appropriate manifest from the manifest server 140.

Using the transformed manifest received from the manifest server 140, the playback client 165 (or another component such as the video delivery system 150) is configured to fetch the storyboard mosaics corresponding to the selected storyboard resolution level(s) from the image server 130 for rendering on the client/user device 160. In an implementation, the transformed manifest includes the unique filenames (e.g., URLs) associated with the storyboard mosaic images maintained by the image server 130.

Implementations of the disclosure may operate within a single server device or on multiple server devices. Although each of the storyboard server 120, the image server 130, the manifest server 140, and the video delivery server 150 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar types of systems and devices. For example, in an implementation, the image server 130, the manifest server 140 and the video delivery server 150 may be combined into a single component configured to perform the functionality described herein with respect to each individual component.

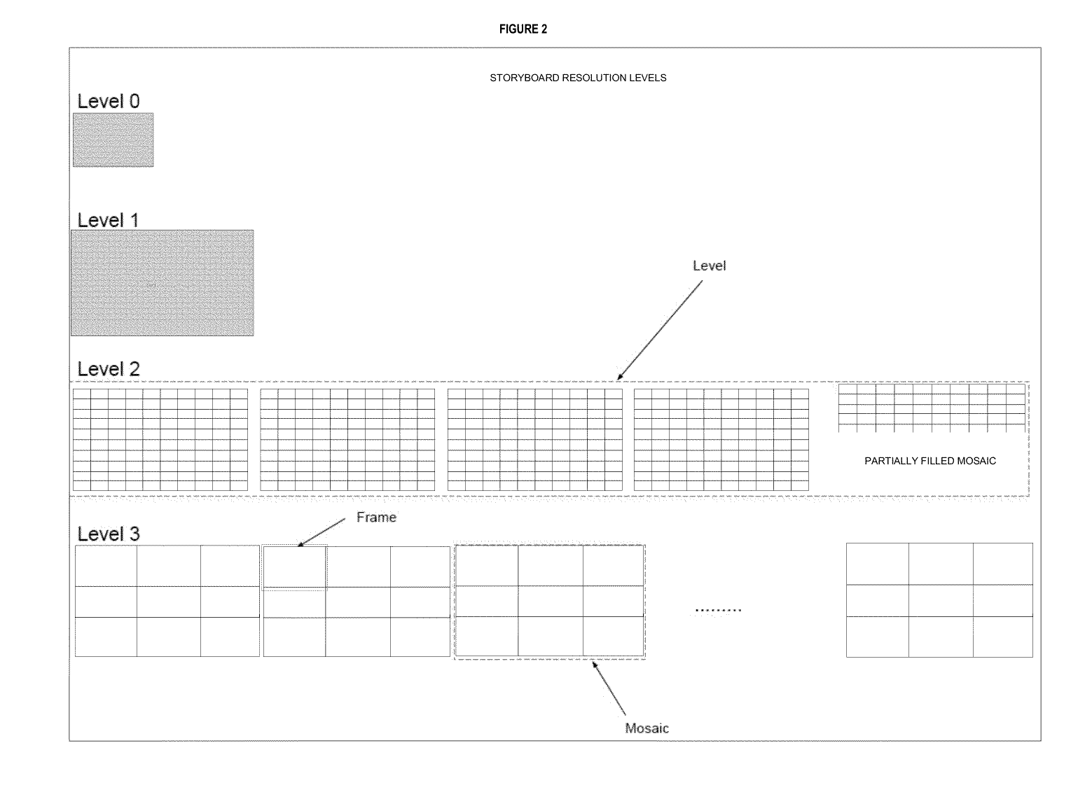

FIG. 2 illustrates exemplary video storyboard including multiple storyboard resolution levels as generated by the storyboard generator 125. In this example, the video storyboard corresponds to a particular video and contains four storyboard resolution levels. Each resolution level has a fixed frame resolution (e.g., 320×240, 160×120, 80×60, and 40×30) and a specific sampling rate (e.g., one video frame every 10 seconds). The video frames are arranged into one or more mosaics. Each mosaic includes a level-specific number of rows and columns of storyboard video frames.

In an implementation, the video frames that make up the mosaics may be selected according to any suitable sampling technique. For example, the video may be segmented into temporal portions (e.g., 10 second portions) and the last frame in the temporal segment can be used as the storyboard image. In another example, the video may be segmented into temporal portions (e.g., 10 second portions) and an algorithm to select an image in each portion, such as, for example, the “best quality” frame, the “most attractive” frame, the “most popular” frame, etc. can be executed.

In yet another example, users may be exposed to a variety of different versions of a video storyboard and the popularity of the storyboard versions may be determined using a measurement and analysis of the user's response or interactivity with the various storyboard versions. In this implementation, the system informs the user of the types of information (e.g., the user's response and activity) that are assembled, compiled, used, transmitted, and stored in the respective application logs and datastores, and provides the user the opportunity to opt-out of having such information assembled and/or shared with the system.

In the example shown in FIG. 2, the storyboard represents a one and a half hour (5,400 second) video and includes the resolution levels as shown in Table 1 below.

TABLE 1
Exemplary Storyboard

| | Frame | Temporal | Spatial | Total Number |
|---|---|---|---|---|
| Level | Resolution | Resolution | Resolution | of Mosaics |
| Level 3 | 320 × 240 | Every 10 seconds | 3 × 3 | 60 mosaics |
| | | | frames/mosaic | |
| Level 2 | 160 × 120 | Every 20 seconds | 9 × 9 | 4 mosaics |
| | | | frames/mosaic | (with 1 |
| | | | | partially filled |
| | | | | in FIG. 2) |
| Level 1 | 80 × 60 | Every 1% of the | 10 × 10 | 1 mosaic |
| | | video | frames/mosaic | |
| Level 0 | 40 × 30 | Every 1% of the | 10 × 10 | 1 mosaic |
| | | video | frames/mosaic | |

In this example, a video playback client (e.g., playback client 165 shown in FIG. 1) initially fetches the lowest storyboard resolution level (e.g., Level 0). Since Level 0 includes only a single mosaic, the fetching process includes only a single image fetch. The resolution at this level is low, but the user can perform seeks (or video location selections) with visual feedback (e.g., the storyboard images) after this single fetch. Advantageously, while the user is seeking through the video, the playback client can fetch additional storyboard frames and levels, and present video frames at the highest available resolution. The fetching and delivery of multiple storyboard resolution levels in an iterative manner can reduce latency by providing a low storyboard resolution level first, then providing a higher resolution level or levels while the user is seeking through the video.

FIG. 3 illustrates a flow diagram of one implementation of a method for delivering a storyboard associated with a video to a client/user device. The method is performed by processing logic that may include hardware (circuitry, dedicated logic, etc.), software (such as is executed on a general purpose computer system or a dedicated machine), or a combination of both. In one implementation, the method 300 illustrated in FIG. 3 may be performed by the storyboard coordinator 155 executing on one or more server machines or another machines as described with respect to FIG. 1.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 310 of method 300, a request is received (e.g., by the storyboard coordinator) for a video from a user device, the request including one or more user device parameters. In an implementation, the video request is sent by a playback client of the user device (e.g., playback client 165 of client/user device 160 shown in FIG. 1). In block 320, in response to the request, a storyboard manifest is retrieved (e.g., by the storyboard coordinator) for a storyboard associated with the requested video. In an implementation, the playback client and/or the storyboard coordinator may be configured to determine the appropriate manifest using an identifier associated with requested video. In an implementation, the storyboard manifest is retrieved from a manifest server (e.g., the manifest server 140 and its associated manifest datastore 145 shown in FIG. 1).

At block 330, a storyboard resolution level is selected using the device parameters. Advantageously, an optimized resolution level may be selected that is appropriate for the user device that initiated the video request. In an implementation, the storyboard coordinator or manifest server transforms the manifest associated with the requested video to include only the selected resolution level, thereby producing a transformed manifest. In another implementation, the storyboard coordinator or manifest server transforms the manifest associated with the requested video to include the selected resolution level and remove one or more inappropriate resolution levels from the manifest, thereby producing a transformed manifest. In an implementation, the transformed manifest is delivered to the playback client of the user device, and the playback client uses the transformed manifest to fetch the storyboard at the selected resolution level.

At block 340, the storyboard is delivered (e.g., by the storyboard coordinator) at the selected resolution level to the user device. In an implementation, the storyboard coordinator receives a fetch request from the playback client using the manifest for the selected storyboard. In this implementation, the storyboard coordinator retrieves the selected storyboard and its associated images from an image server (e.g., the image server 130 and its associated storyboard mosaic file datastore 135 shown in FIG. 1). Following delivery of the storyboard at the selected resolution level, the playback client renders the storyboard for use by the user in seeking through the video to select a desired playback location. In an implementation, the storyboard may be rendered to the user via any suitable display.

Optionally (as denoted by the dashed lines in FIG. 3), at block 350, following delivery of the storyboard at the selected resolution level, a new fetch request may be received by the storyboard coordinator from the playback client. The new fetch request may be for additional storyboard frames and storyboard resolution levels at the highest available resolution, including a resolution level that is higher than the selected resolution level initially delivered to the playback client, using a change or an update to the device parameters (e.g., an increase in the client/user device's 160 available bandwidth). Advantageously, while a user is seeking through the video using the storyboard at the selected resolution level that was initially delivered, one or more fetch requests may be made by the playback client. In response to the additional fetch request(s), the storyboard coordinator can facilitate the delivery of higher resolution levels of the storyboard and/or higher resolution storyboard frames. In an implementation, the user device may initially receive the storyboard at a low resolution level to limit the storyboard delivery latency, and receive a higher resolution level, e.g., while a user is seeking through the initially delivered storyboard to optimize the user's viewing experience.

FIG. 4 illustrates a flow diagram of one implementation of a method for delivering a storyboard associated with a live video stream to a client/user device. The method is performed by processing logic that may include hardware (circuitry, dedicated logic, etc.), software (such as is executed on a general purpose computer system or a dedicated machine), or a combination of both. In one implementation, the method 400 illustrated in FIG. 4 may be performed by the storyboard generator 125 executing on one or more server machines or another machines as described with respect to FIG. 1.

At block 410, a live video stream is received (e.g., by a storyboard generator 125) from a video source. One having ordinary skill in the art will appreciate that any suitable video source provisioning a live video stream may be utilized in connection with implementations of the present disclosure. For example, as shown in FIG. 1, the live video stream may be received by the storyboard generator 125 directly from an uploader 105 (e.g., a video source) or via a video storage pipeline (e.g., the video datastore 110).

At block 420, as the live video stream is received, multi-frame sampling of the incoming live video stream is performed (e.g., by the storyboard generator) to yield multiple video frames. In an implementation, the storyboard generator continuously performs the sampling as the live video stream is received.

At block 430, a storyboard including the multiple video frames is produced. In an implementation, the newly produced video frames are added to the storyboard, and the affected mosaic at the end of each storyboard resolution level is updated with the new frames. In addition, the storyboard manifest associated with the live video stream can be updated to reflect the additions to the affected mosaic(s). In an implementation, each time the mosaics are updated to include one or more new frames, the updated version of each mosaic is assigned a new mosaic filename with an increasing version number, to avoid inconsistencies caused by front end, proxy or client level caching.

Next, at block 440, the generated storyboard associated with the live video stream is delivered to the user device. In an implementation, the storyboard provides visual feedback associated with the previously viewed/recorded portion of the live video stream. Advantageously, the blocks of instruction 400 may be performed continuously with regard to a live video stream to deliver a continuously updated storyboard corresponding to the live video stream.

According to an implementation, the playback client sends continuous fetch requests to receive the continuously updated manifest and retrieve the continuously updated mosaics. In an implementation, the one or more fetch requests may include device parameters associated with the user device. As described in detail above, the storyboard coordinator may select an appropriate storyboard resolution level corresponding to the live video stream using the device parameters. In this case, the live video stream storyboard may be continuously updated and provided to the user at a customized resolution level suitable for the user device.

In an implementation, the multiple storyboard resolution levels of the present disclosure facilitates advanced rendering techniques in that the playback client can employ multi-resolution texture mapping to render 3D projections of storyboard frame ribbons (also known as “mipmaps”), in accordance with techniques known to one having ordinary skill in the art.

In an implementation, the playback client and the storyboard coordinator may implicitly agree on an appropriate storyboard format (e.g., an optimized storyboard resolution), and therefore, a manifest is not utilized. For example, the playback client may be configured to play all videos at a selected storyboard resolution. This configuration can be hard-coded into the playback client.

In another implementation, the playback client may be configured to create a manifest using parameters of the requested video (e.g., the duration of the video, the resolution of the video). In this implementation, the playback client may generate the manifest without communicating with a remote datastore (e.g., the manifest datastore) to retrieve a manifest or manifest information.

In another implementation, the playback client may receive a standard device independent manifest or create a standard manifest (without communicating with a remote datastore) that is initially independent of device parameter considerations. The user device itself then proceeds to use a subset of the information in the thus created manifest. In this implementation, the playback client may, for example, choose to ignore the highest resolution level to maximize the display quality to the user device or to conserve bandwidth or CPU resources for the fetching or display of storyboard imagery.

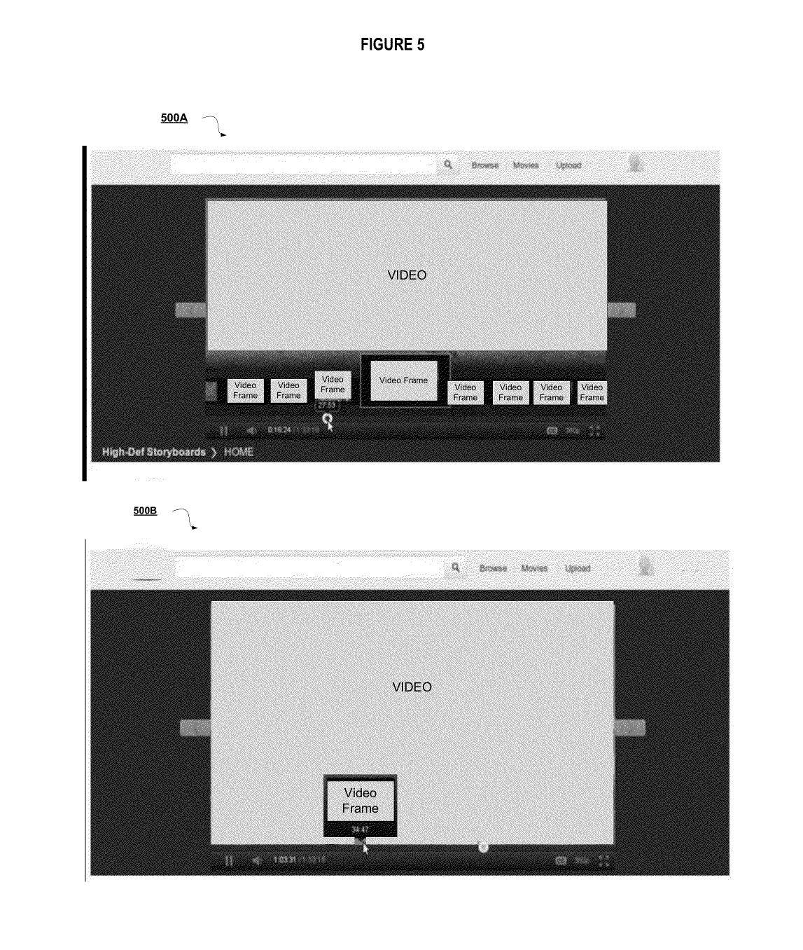

FIG. 5 illustrates an exemplary user interface of a playback client displaying exemplary storyboards 500A and 500B generated in accordance with implementations of the present disclosure.

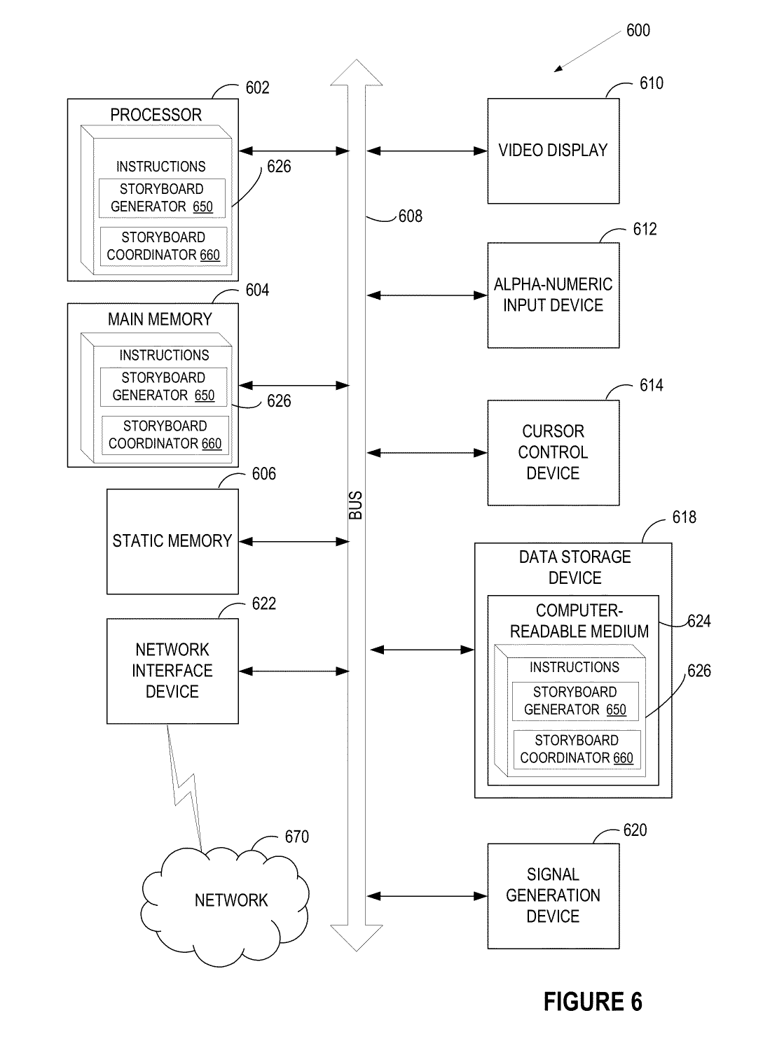

FIG. 6 illustrates a diagrammatic representation of a machine in the exemplary form of a computer system 600 within which a set of instructions, for causing the machine to perform any one or more of the methodologies discussed herein, may be executed. In implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device (processor) 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein, illustrated in FIG. 6 by depicting instructions 626 within processor 602.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 618 may include a computer-readable storage medium 624 on which is stored one or more sets of instructions 626 (e.g., software) embodying any one or more of the methodologies or functions described herein. The instructions 626 may also reside, completely or at least partially, within the main memory 604 and/or within the processor 602 during execution thereof by the computer system 600, the main memory 604 and the processor 602 also constituting computer-readable storage media. The instructions 626 may further be transmitted or received over a network 670 via the network interface device 622.

In one implementation, the instructions 626 include instructions for a storyboard generator 650 and/or a storyboard coordinator 660, which may respectively correspond to storyboard generator 125 and the storyboard coordinator 155 of FIG. 1, and/or a software library containing instructions that call storyboard generator 650 and/or storyboard coordinator 660. While the computer-readable storage medium 624 is shown in an exemplary implementation to be a single medium, the term “computer-readable storage medium” should be taken to include a single medium or multiple media (e.g., a centralized or distributed datastore, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless stated otherwise as apparent from the following discussion, it is appreciated that throughout the description, discussions utilizing terms such as “receiving”, “obtaining”, “selecting”, “delivering”, “transforming”, “performing”, “generating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

We claim:

1. A method of delivering a storyboard associated with a video, comprising:
receiving, from a playback client executed on a user device, a request for a video, the request comprising one or more user device parameters;
obtaining a storyboard manifest comprising information defining a storyboard associated with the video, wherein the information comprises a plurality of storyboard resolution levels;
selecting, using one or more user device parameters, one of the plurality of storyboard resolution levels from the storyboard manifest; and
delivering, to the playback client, the storyboard at the selected storyboard resolution level.

2. The method of claim 1 further comprising:
transforming the storyboard manifest to remove one or more inapplicable storyboard resolution levels; and
delivering the transformed storyboard manifest to the playback client.

3. The method of claim 2 further comprising receiving a fetch request from the playback client for the storyboard at the selected storyboard resolution level.

4. The method of claim 3 further comprising receiving a second fetch request from the playback client for the storyboard at a higher storyboard resolution level than the selected storyboard resolution level.

5. The method of claim 1, wherein the storyboard comprises one or more storyboard mosaics.

6. The method of claim 5 further comprising storing an image of each storyboard mosaic with a specific mosaic filename.

7. The method of claim 6, wherein the storyboard manifest comprises the specific mosaic filename for each storyboard mosaic image.

8. The method of claim 1, wherein the storyboard manifest is stored with a manifest filename associated with an identifier of the video.

9. The method of claim 8, wherein the playback client is configured to determine the manifest filename using the identifier of the video and fetch the storyboard manifest.

10. The method of claim 1 further comprising delivering the storyboard manifest to the playback client configured to fetch the storyboard in accordance with the storyboard manifest.

11. A method of delivering a storyboard associated with a live video stream, comprising:
receiving a live video stream;
performing multi-frame sampling of the live video stream to produce a plurality of video frames;
generating a storyboard comprising the plurality of video frames; and
delivering, to a playback client executed on a user device, the storyboard associated with the live video stream.

12. The method of claim 11 further comprising adding one or more newly produced video frames to a mosaic at an end of a storyboard resolution level to produce a modified mosaic.

13. The method of claim 12 further comprising updating a storyboard manifest associated with the storyboard to reflect the modified mosaic.

14. The method of claim 11 further comprising generating a storyboard manifest comprising information defining the generated storyboard associated with the live video stream, wherein the information comprises a plurality of storyboard resolution levels.

15. The method of claim 14 further comprising:
receiving, from the playback client, one or more user device parameters;
selecting, using the one or more user device parameters, one of the plurality of storyboard resolution levels; and
delivering, to the playback client, the storyboard at the selected storyboard resolution level.

16. A non-transitory computer readable storage medium having instructions that, when executed by a processing device, cause the processing device to perform operations comprising:
receive, from a playback client executed on a user device, a request for a video, the request comprising one or more user device parameters;
obtain a storyboard manifest comprising information defining a storyboard associated with the video, wherein the information comprises a plurality of storyboard resolution levels;
select, using the one or more user device parameters, one of the plurality of storyboard resolution levels from the storyboard manifest; and
deliver, to the playback client, the storyboard at the selected storyboard resolution level.

17. A non-transitory computer readable storage medium having instructions that, when executed by a processing device, cause the processing device to perform operations comprising:
receive a live video stream;
perform multi-frame sampling of the live video stream to produce a plurality of video frames;
generate a storyboard comprising the plurality of video frames; and
deliver, to a playback client executed on a user device, the storyboard associated with the live video stream.

18. A computing device comprising:
a memory; and
a processing device coupled to the memory, wherein the processing device is configured to:
receive, from a playback client executed on a user device, a request for a video, the request comprising one or more user device parameters,
obtain a storyboard manifest comprising information defining a storyboard associated with the video, wherein the information comprises a plurality of storyboard resolution levels,
select, using the one or more user device parameters, one of the plurality of storyboard resolution levels from the storyboard manifest, and
deliver, to the playback client, the storyboard at the selected storyboard resolution level.

19. A computing device comprising:
a memory; and
a processing device coupled to the memory, wherein the processing device is configured to:
receive a live video stream,
perform multi-frame sampling of the live video stream to produce a plurality of video frames,
generate a storyboard comprising the plurality of video frames, and
deliver, to a playback client executed on a user device, the storyboard associated with the live video stream.

20. A method of obtaining a storyboard associated with a video, comprising:
determining one or more user device parameters;
transmitting a request for a video, the request comprising the one or more user device parameters;
receiving a storyboard manifest comprising information defining a storyboard associated with the video and a storyboard resolution level selected using the one or more user device parameters; and
obtaining, using the storyboard manifest, the storyboard at the selected storyboard resolution level.

21. A computing device comprising:
a memory; and
a processing device coupled to the memory, wherein the processing device is configured to:
determine one or more user device parameters,
transmit a request for a video, the request comprising the one or more user device parameters,
receive a storyboard manifest comprising information defining a storyboard associated with the video and a storyboard resolution level selected using the one or more user device parameters, and
obtain, using the storyboard manifest, the storyboard at the selected storyboard resolution level.

22. The computer device of claim 21, wherein the processing device is further configured to facilitate rendering of the storyboard at the selected resolution level via a display.

23. A method of delivering a storyboard associated with a video, comprising:
receiving, from a playback client executed on a user device, a request for a video, the request comprising a device parameter indicating a selected storyboard resolution level; and
delivering, to the playback client, the storyboard at the selected storyboard resolution level.

24. A method of obtaining a storyboard associated with a video, comprising:
transmitting a request for a video, the request comprising the one or more user device parameters;
receiving the video;
generating a storyboard manifest comprising information defining a storyboard associated with the video and a storyboard resolution level selected using one or more parameters associated with the video; and
obtaining, using the storyboard manifest, the storyboard at the selected storyboard resolution level.

25. A method of obtaining a storyboard associated with a video, comprising:
determining, by a playback client executed on a user device, one or more user device parameters;
selecting, using the one or more user device parameters, one of a plurality of storyboard resolution levels for playback of a storyboard associated with a video;
fetching the storyboard at the selected storyboard resolution level; and
presenting the storyboard at the selected storyboard resolution level.
